(19) United States
(12) Patent Application Publication
(10) Pub. No.: US 2014/0009866 A1
(43) Pub. Date: Jan. 9, 2014

(54) CAPACITOR, STRUCTURE AND METHOD OF FORMING CAPACITOR

(71) Applicant: Taiyo Yuden Co., Ltd., Tokyo (JP)

(72) Inventors: Hidetoshi MASUDA, Tokyo (JP); Shinya MASUNO, Tokyo (JP); Yoshinari TAKE, Tokyo (JP)

(21) Appl. No.: 13/933,706

(22) Filed: Jul. 2, 2013

(30) Foreign Application Priority Data
Jul. 3, 2012 (JP) 2012-149130

(51) Int. Cl. H01G 4/005

(52) U.S. Cl. CPC H01G 4/005
USPC 361/306.1

(57) ABSTRACT

There is provided a capacitor including a dielectric layer having a first plane, a second plane opposite to the first plane, and a plurality of through-holes communicated with the first plane and the second plane; a first external conductor layer disposed on a part of the first plane; a second external conductor layer disposed on the second plane; a third external conductor layer disposed on another part of the first plane; a first internal conductor housed in a part of a plurality of the through-holes and connected to the first external conductor layer; a second internal conductor housed in another part of a plurality of the through-holes and connected to the second external conductor layer; and a third internal conductor housed in the other part of a plurality of the through-holes and connected to the second external conductor layer and the third external conductor layer.

### CROSS-REFERENCE TO RELATED APPLICATION

This application claims priority under 35 U.S.C. §119 to Japanese Patent Application No. JP 2012-149130 filed on Jul. 3, 2012, the entire content of which is hereby incorporated herein by reference in its entirety.

### FIELD

The present disclosure relates to a porous capacitor.

### BACKGROUND

In recent years, as a new type capacitor, a porous capacitor has been developed. The porous capacitor takes advantages of a tendency that a metal oxide formed on a surface of a metal such as aluminum forms a porous structure. The porous capacitor is configured by forming electrodes in pores and using the metal oxide as a dielectric.

Conductors are laminated on front and back surfaces of the dielectric. The electrodes formed in the pores are connected to either of the conductors on the front surface or the conductors on the back surface. In this way, the electrodes formed in the pores function as counter electrodes facing each other via the dielectric.

As described above, as the conductors are formed on the front and back surfaces of the dielectric, wirings and terminals for mounting the capacitor to a substrate are generally connected to the front and back surfaces of the capacitor. For example, a capacitor disclosed in Japanese Patent Application Laid-open No. 2009-049212 includes a dielectric having pores, conductors formed on front and back surfaces of the dielectric, and wirings connected to the front and back surfaces.

### SUMMARY

The capacitor described in Japanese Patent Application Laid-open No. 2009-049212 has the configuration that the wirings are connected to the conductors formed on the front and back surfaces of the dielectric. The wirings formed on the both surfaces of the capacitor should be connected to terminals of a substrate when the capacitor is mounted on the substrate. Undesirably, it makes a mounting process complex, or a mounting area becomes larger than a device area of the capacitor.

In view of the above-mentioned circumstances, it is desirable to provide a capacitor having excellent mountability.

According to an embodiment of the present disclosure, there is provided a capacitor including a dielectric layer, a first external conductor layer, a second external conductor layer, a third external conductor layer, a first internal conductor, a second internal conductor, and a third internal conductor.

The dielectric layer includes a first plane, a second plane opposite to the first plane, and a plurality of through-holes communicated with the first plane and the second plane.

The first external conductor layer is disposed on a part of the first plane.

The second external conductor layer is disposed on the second plane.

The third external conductor layer is disposed another part of the first plane.

The first internal conductor is housed in a part of a plurality of the through-holes and connected to the first external conductor layer.

The second internal conductor is housed in another part of a plurality of the through-holes and connected to the second external conductor layer.

The third internal conductor is housed in the other part of a plurality of the through-holes and connected to the second external conductor layer and the third external conductor layer.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a cross-sectional view showing a capacitor according to a first embodiment of the present disclosure;

FIG. 2 is a cross-sectional view showing a part of a configuration of the capacitor;

FIG. 3 is a cross-sectional view showing a part of a configuration of the capacitor;

FIG. 4 is a cross-sectional view showing a dielectric layer of the capacitor;

FIG. 5 is a perspective view of the capacitor;

FIG. 6 is a perspective view showing a part of a configuration of the capacitor;

FIG. 7 is a perspective view showing a part of a configuration of the capacitor;

FIG. 8 is a perspective view showing a part of a configuration of the capacitor;

FIG. 9 is a perspective view showing the dielectric layer of the capacitor;

FIGS. 10A to 10C each is a schematic view showing a method of forming the capacitor;

FIGS. 11A to 11C each is a schematic view showing a method of forming the capacitor;

FIGS. 12A to 12C each is a schematic view showing a method of forming the capacitor;

FIGS. 13A to 13C each is a schematic view showing a method of forming the capacitor;

FIGS. 14A to 14C each is a schematic view showing a method of forming the capacitor;

FIGS. 15A to 15C each is a schematic view showing a method of forming the capacitor;

FIGS. 16A to 16C each is a schematic view showing a method of forming the capacitor;

FIGS. 17A to 17C each is a schematic view showing a method of forming the capacitor;

FIGS. 18A to 18C each is a schematic view showing a method of forming the capacitor;

FIG. 19 is a cross-sectional view showing a capacitor according to Comparative Example;

FIG. 20 is a cross-sectional view showing a capacitor according to Modification Example of the present disclosure; and

FIG. 21 is a cross-sectional view showing the capacitor according to Modification Example of the present disclosure.

### DETAILED DESCRIPTION OF THE EMBODIMENTS

According to an embodiment of the present disclosure, there is provided a capacitor including a dielectric layer, a first external conductor layer, a second external conductor layer, a third external conductor layer, a first internal conductor, a second internal conductor, and a third internal conductor.

The dielectric layer includes a first plane, a second plane opposite to the first plane, and a plurality of through-holes communicated with the first plane and the second plane.

The first external conductor layer is disposed on a part of the first plane.

The second external conductor layer is disposed on the second plane.

The third external conductor layer is disposed another part of the first plane.

The first internal conductor is housed in a part of a plurality of the through-holes and connected to the first external conductor layer.

The second internal conductor is housed in another part of a plurality of the through-holes and connected to the second external conductor layer.

The third internal conductor is housed in the other part of a plurality of the through-holes and connected to the second external conductor layer and the third external conductor layer.

By this configuration, the first internal conductors that configure one of the counter electrodes of the capacitor are connected to the first external conductor layer. The second internal conductors that configure the other of the counter electrodes of the capacitor are connected to the third external conductor layer via the second external conductor layer and the third internal conductors. As both of the first external conductor layer and the third external conductor layer are formed on the first plane of the dielectric, the capacitor allows the first plane to be conducted with the both counter electrodes (the first internal conductors and the second internal conductors).

The capacitor may further comprise a first protective layer coating the first external conductor layer and the third external conductor layer; a second protective layer coating the second external conductor layer; a first terminal disposed on the first protective layer and connected to the first external conductor layer; and a second terminal disposed on the first protective layer and connected to the second external conductor layer.

By this configuration, the first terminal and the second terminal disposed on the first protective layer allow the both counter electrodes (the first internal conductors and the second internal conductors) of the capacitor to be conducted. Suppose that the third internal conductors and the third external conductor layer are not formed, the second terminal should be connected to the second external conductor layer disposed at the second plane of the dielectric. Depending on a length of wiring, Equivalent Series Resistance (ESR) may be undesirably increased. However, in the capacitor according to the embodiment, the second terminal can be directly connected to the third external conductor layer formed on the first plane. It is thus possible to overcome the problems including an increase of ESR.

A first opening communicating with the first external conductor layer and a second opening communicating with the third external conductor layer are formed on the first protective layer. The first terminal is connected to the first external conductor layer via the first opening. The second terminal is connected to the third external conductor layer via the second opening.

By this configuration, it is possible that the first terminal and the second terminal are connected to the first external conductor layer and the third external conductor layer, respectively, after the first protective layer is formed. In other words, there is no need to dispose wirings etc. before the first protective layer is formed. It is thus possible to form the capacitor by effective forming processes. Also, it is possible to reduce a connection distance between the first terminal and the first external conductor layer and a connection distance between the second terminal and the second external conductor layer as short as possible, which is effective to decrease the ESR etc.

The dielectric layer may be made of aluminum oxide.

Aluminum oxide can be produced by anodic oxidizing aluminum. In this regard, an infinite number of holes are generated by a self-organizing action of aluminum oxide. By adjusting the conditions (such as a voltage) of the anodic oxidation, it is possible to control a pore diameter and a pitch of the holes. In other words, aluminum oxide can be used as the dielectric layer of the capacitor according to the embodiment.

Hereinafter, embodiments of the present disclosure will be described with reference to the drawings.

### (Capacitor Configuration)

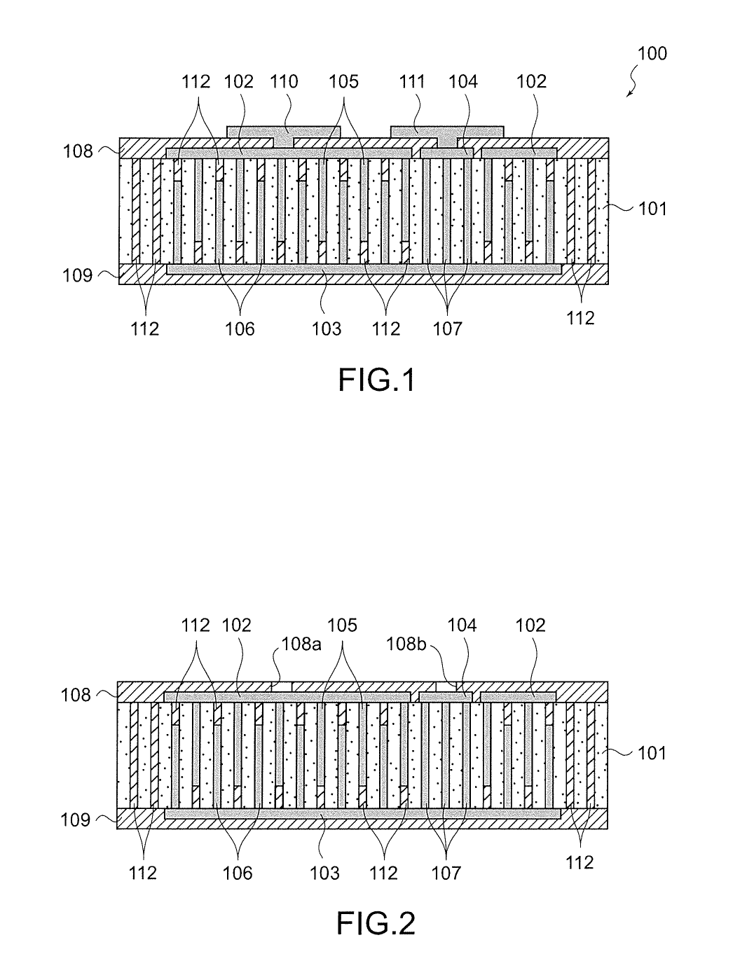

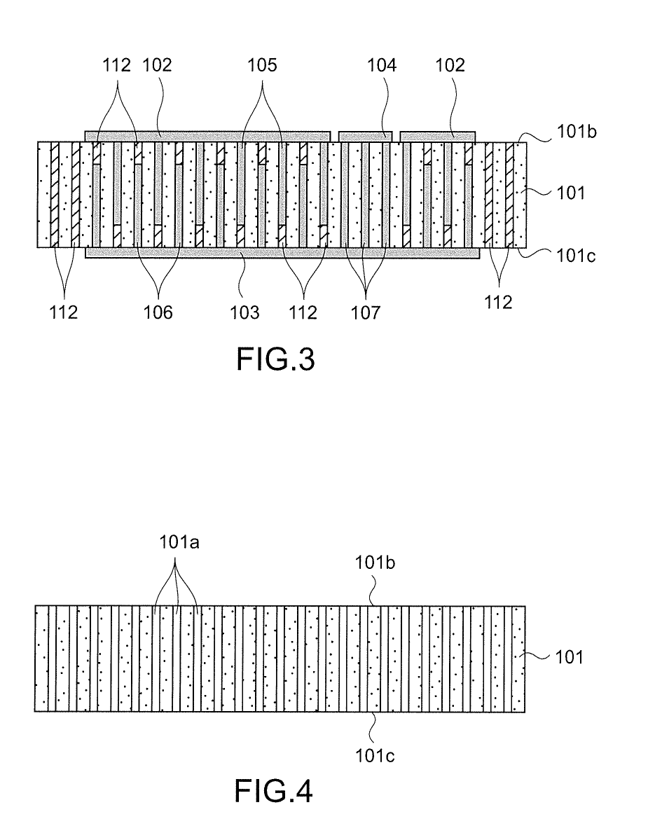

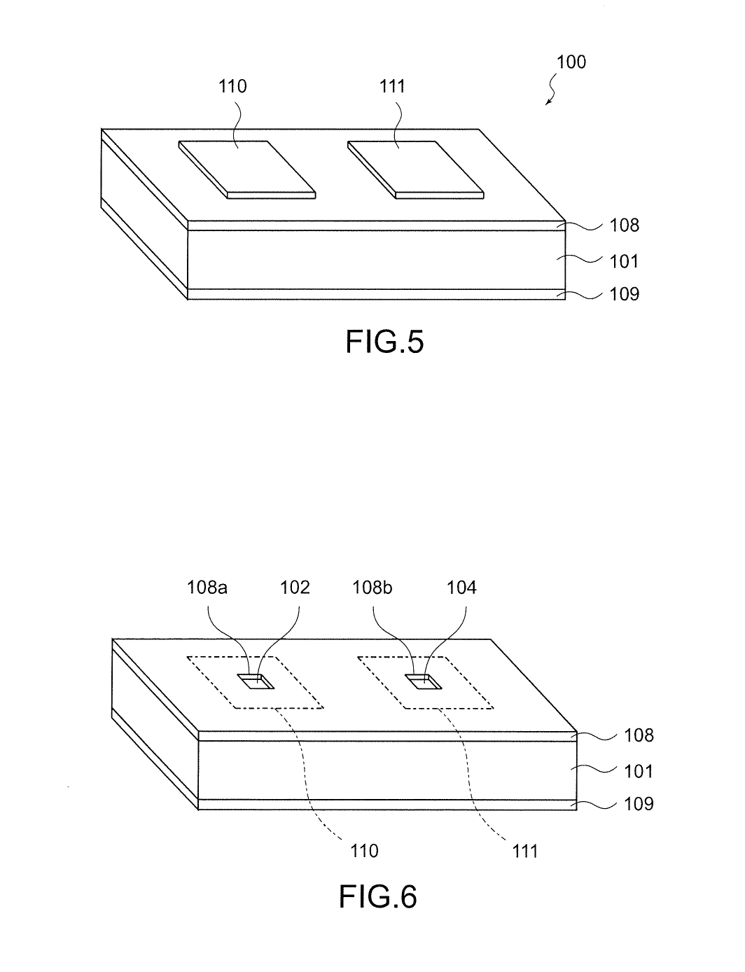

FIG. 1 is a cross-sectional view showing a capacitor 100 according to a first embodiment of the present disclosure. FIGS. 2 and 3 are each a cross-sectional view showing a part of the capacitor 100. FIG. 5 is a perspective view of the capacitor 100. FIGS. 6 to 8 are each a perspective view of a part configuration of the capacitor 100. As shown in these drawings, the capacitor 100 has a dielectric layer 101, a first external conductor layer 102, a second external conductor layer 103, a third external conductor layer 104, first internal conductors 105, second internal conductors 106, third internal conductors 107, a first protective layer 108, a second protective layer 109, a first terminal 110, a second terminal 111 and internal insulators 112.

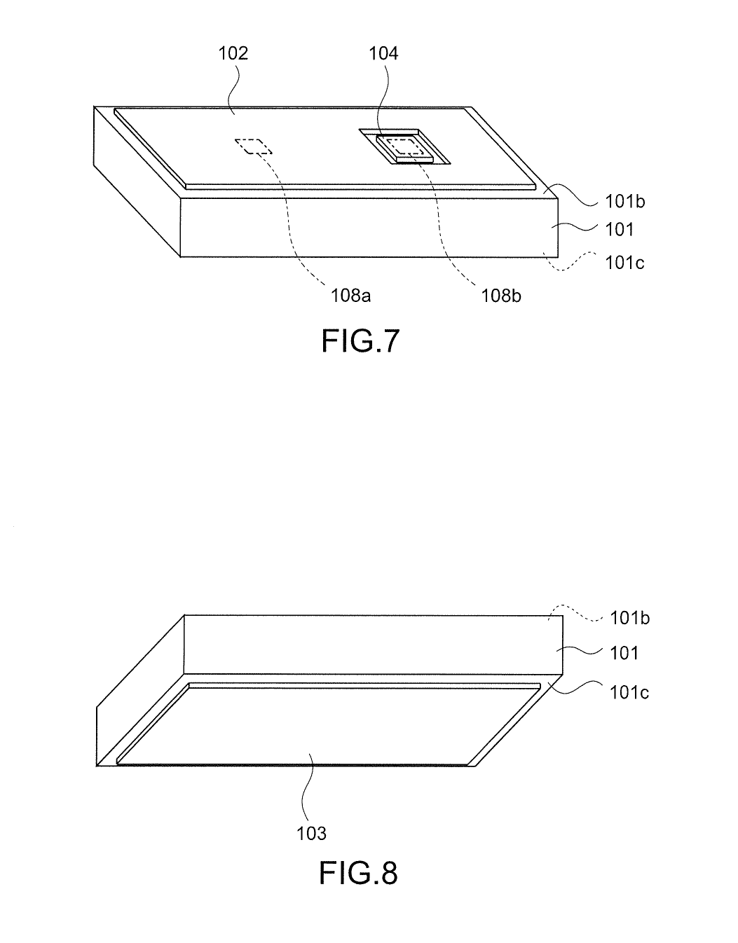

FIG. 2 is a cross-sectional view showing the capacitor 100 excluding the first terminal 110 and the second terminal 111. FIG. 3 is a cross-sectional view showing the capacitor 100 excluding the first protective layer 108 and the second protective layer 109. FIG. 6 is a perspective view showing the capacitor 100 excluding the first terminal 110 and the second terminal 111. FIG. 7 is a perspective view showing the capacitor 100 excluding the first protective layer 108 and the second protective layer 109. FIG. 8 is a perspective view showing a back surface of the capacitor 100 of FIG. 7.

As shown in FIG. 3, the first internal conductors 105, the second internal conductors 106, the third internal conductors 107 and the internal insulators 112 are housed in through-holes (described later) formed in the dielectric layer 101. The first external conductor layer 102 and the third external conductor layer 104 are disposed at one face of the dielectric layer 101, and the second external conductor layer 103 is disposed at an opposite surface of the dielectric layer 101. The first internal conductors 105 are connected to the first external conductor layer 102. The second internal conductors 106 are connected to the second external conductor layer 103. The third internal conductors 107 are connected to the second external conductor layer 103 and the third external conductor layer 104.

As shown in FIG. 2, the first external conductor layer 102 and the third external conductor layer 104 are coated with the first protective layer 108. The second external conductor layer 103 is coated with the second protective layer 109. As shown in FIG. 1, the first terminal 110 and the second terminal 111 are disposed on the first protective layer 108. The first terminal 110 is connected to the first external conductor layer 102, and the second terminal 111 is connected to the third external conductor layer 104.

The dielectric layer 101 functions as a dielectric of the capacitor 100. The dielectric layer 101 is made of a dielectric material capable of forming through-holes (pores), e.g., aluminum oxide (Al₂O₃). Also, the dielectric layer 101 may be made of an oxide of a bulb metal (Al, Ta, Na, Ti, Zr, Hf, Zn, W, Sb). The thickness of the dielectric layer 101 is not particularly limited. For example, the dielectric layer 101 has a thickness of several μms to hundreds μms.

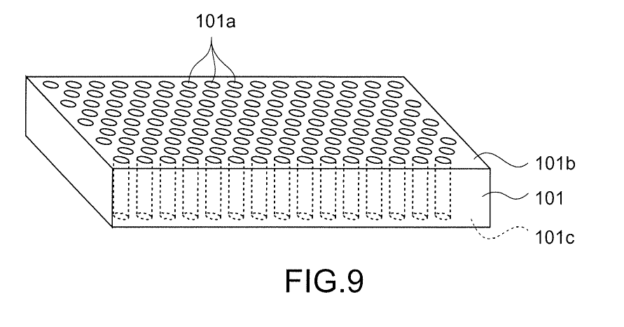

FIG. 4 is a perspective view showing the dielectric layer 101. FIG. 9 is a perspective view showing the dielectric layer 101. As shown in these Figures, a plurality of through-holes (pores) 101a is formed in the dielectric layer 101. A plane in parallel with a laminar direction of the dielectric layer 101 is defined as a first plane 101b, and an opposite plane thereof is defined as a second plane 101c. Respective through-holes 101a are formed in a direction perpendicular to the first plane 101b and the second plane 101c (in a thickness direction of the dielectric layer 101), and are communicated with the first plane 101b and the second plane 101c. The number and the size of the through-holes 101a shown in FIG. 4 etc. are illustrative. In practice, many smaller-sized through-holes 101a may be formed.

The shape (cross-sectional shape) of each through-hole 101a is not particularly limited, and may be almost circle having an inner diameter of several tens nm to hundreds nms Also, the space of the through-holes 101a adjacent is not particularly limited, and may be several tens nm to hundreds nms

The first external conductor layer 102 electrically connects the first internal conductors 105 to the first terminal 110. The first external conductor layer 102 is disposed at a part (a partial area) of the first plane 101b of the dielectric layer 101 spaced from the third external conductor layer 104, as shown in FIGS. 3 and 7. The first external conductor layer 102 may be made of a conductive material, e.g., a pure metal such as Cu, Ni, Cr, Ag, Pd, Fe, Sn, Pb, Pt, Ir, Rh, Ru, Al and Ti or an alloy thereof. The thickness of the first external conductor layer 102 may be several tens nm to several μms. The first external conductor layer 102 may be disposed such that a plurality of conductive material layers is laminated.

The second external conductor layer 103 electrically connects the second internal conductors 106 to the third internal conductors 107. The second external conductor layer 103 is disposed at the second plane 101c of the dielectric layer 101, as shown in FIGS. 3 and 8. The second external conductor layer 103 may be made of the conductive material used in the first external conductor layer 102. The thickness of thereof may be several nm to several μms. The constituent material of the second external conductor layer 103 may be the same or different as/from the constituent material of the first external conductor layer 102. Also, the second external conductor layer 103 may be disposed such that a plurality of conductive material layers is laminated.

The third external conductor layer 104 electrically connects the third internal conductors 107 to the second terminal 111. The third external conductor layer 104 is disposed at other part (a partial area where the first external conductor layer 102 is not formed) of the first plane 101b of the dielectric layer 101 spaced from the first external conductor layer 102, as shown in FIGS. 3 and 7. The third external conductor layer 104 may be made of the conductive material used in the first external conductor layer 102. The thickness of thereof may be several nm to several μms. The constituent material of the third external conductor layer 104 may be the same or different as/from the constituent material of the first external conductor layer 102 and the second external conductor layer 103. Also, the third external conductor layer 104 may be disposed such that a plurality of conductive material layers is laminated.

The first internal conductors 105 function as one of counter electrodes of the capacitor 100. As shown in FIG. 3, the first internal conductors 105 are formed such that they are housed in a part of a plurality of the through-holes 101a (see FIG. 4), are connected to the first external conductor layer 102, but are not connected to the second external conductor layer 103. Between the first internal conductors 105 and the second external conductor layer 103, the internal insulators 112 may be disposed, but there may be just a space. The first internal conductors 105 may be made of a conductive material, e.g., a pure metal such as Cu, Ni, Co, Cr, Ag, Au, Pd, Fe, Sn, Pb and Pt or an alloy thereof. In FIGS. 1 to 3, several first internal conductors 105 are shown, but more first internal conductors 105 may be actually formed.

The second internal conductors 106 function as the other of the counter electrodes of the capacitor 100. As shown in FIG. 3, the second internal conductors 106 are formed such that they are housed in other part of a plurality of the through-holes 101a (the through-hole 101a where the first internal conductors 105 are not formed) (see FIG. 4), are connected to the second external conductor layer 103, but are not connected to the first external conductor layer 102. Between the second internal conductors 106 and the first external conductor layer 102, the internal insulators 112 may be disposed, but there may be just a space. The second internal conductors 106 may be made of the conductive material used in the first internal conductors 105. The material of the second internal conductors 106 may be the same or different as/from the material of the first internal conductors 105. In FIGS. 1 to 3, several second internal conductors 106 are shown, but more second internal conductors 106 may be actually formed.

The third internal conductors 107 electrically connects the second external conductor layer 103 to the third external conductor layer 104. As shown in FIG. 3, the third internal conductors 107 are housed in other part of a plurality of the through-holes 101a (the through-hole 101a where the first internal conductors 105 and the second internal conductors 106 are not formed) (see FIG. 4) and are connected to the second external conductor layer 103 and the third external conductor layer 104. The third internal conductors 107 may be made of the conductive material used in the first internal conductors 105 and the second internal conductors 106. The material of the third internal conductors 107 may be the same or different as/from the material of the first internal conductors 105 and the second internal conductors 106. In FIGS. 1 to 3, several third internal conductors 107 are shown, but more third internal conductors 107 may be actually formed.

As shown in FIGS. 1 to 3, excluding the area where the third internal conductors 107 are formed, the first internal conductors 105 and the second internal conductors 106 are arranged alternately. They may be not necessarily disposed alternately, and may be arranged randomly. A numerical percentage of the first internal conductors 105 and the second internal conductors 106 is not particularly limited. However, it is desirable that the percentage of respective conductors is similar, as the capacitor 100 can have high capacity. The numbers of the third internal conductors 107 may be such that the second external conductor layer 103 and the third external conductor layer 104 are electrically connected with certainty.

As shown in FIGS. 2 and 6, the first protective layer 108 coats, protects and insulates externally the first external conductor layer 102 and the third external conductor layer 104. The first protective layer 108 may be made of an insulating material such as a synthetic resin, and may have a thickness of several nm to several μms. In the first protective layer 108, a first opening 108a and a second opening 108b are formed by partly removing the first protective layer 108.

The first opening 108a is formed immediately above the first external conductor layer 102 (see FIG. 7), i.e., the first external conductor layer 102 is exposed by the first opening 108a. A shape or a size of the first opening 108a is not especially limited as long as an electrical connection between the first terminal 110 and the first external conductor layer 102 with certainty, as described later. The second opening 108b is formed immediately above the third external conductor layer 104 (see FIG. 7), i.e., the third external conductor layer 104 is exposed by the second opening 108b. A shape or a size of the second opening 108b is not especially limited as long as an electrical connection between the second terminal 111 and the third external conductor layer 104 with certainty, as described later.

As shown in FIG. 2, the second protective layer 109 coats, protects and insulates externally the second external conductor layer 103. The second protective layer 109 may be made of an insulating material such as a synthetic resin, and may have a thickness of several nm to several μms. In the second protective layer 109, no opening is formed dissimilar to the protective layer 108.

As shown in FIGS. 1 and 5, the first terminal 110 is disposed on the first protective layer 108, and is electrically connected to the first external conductor layer 102 via the first opening 108a (see FIG. 2). As shown in FIG. 6, the first terminal 110 is formed immediately above the first opening 108a, and a part thereof is formed within the first opening 108a and over a predetermined range of the first protective layer 108. The constituent material of the first terminal 110 may be the conductive material, but is not limited thereto.

As shown in FIGS. 1 and 5, the second terminal 111 is disposed on the first protective layer 108, and is electrically connected to the third external conductor layer 104 via the second opening 108b (see FIG. 2). As shown in FIG. 6, the second terminal 111 is formed immediately above the second opening 108b, and a part thereof is formed within the second opening 108a and over a predetermined range of the first protective layer 108. The second terminal 111 is formed spaced from the first terminal 110. The constituent material of the second terminal 111 may be the conductive material, but is not limited thereto.

As shown in FIG. 3, the internal insulators 112 are formed within the through-holes 101a (see FIG. 4) positioned at peripheral of the dielectric layer 101, between the first internal conductors 105 and the second external conductor layer 103, and between the second internal conductors 106 and the second external conductor layer 102. The internal insulators 112 maintain intensities of the through-holes 101a where none of the first internal conductors 105, the second internal conductors 106 and the third internal conductors 107 is formed.

The capacitor 100 has the above-described configuration. As shown in FIG. 1, the first internal conductors 105 and the second internal conductors 106 are faced each other via the dielectric layer 101, i.e., the first internal conductors 105 and the second internal conductors 106 function as the counter electrodes of the capacitor 100. The first internal conductors 105 are connected to the first terminal 110 via the first external conductor layer 102, and the second internal conductors 106 are connected to the second terminal 111 via the second external conductor layer 103, the third internal conductors 107 and the third external conductor layer 104.

In this way, both the first terminal 110 and the second terminal 111 conducted to the counter electrodes (the first internal conductors 105 and the second internal conductors 106) are formed on the same face (the face at the first protective layer 108). Advantageously, this allows the capacitor 100 to be mounted easily on the substrate, and an equivalent series resistance of the capacitor 100 to be decreased (described later).

The first internal conductors 105 and the second internal conductors 106 have nano-scaled microstructures, and are adjacent each other. A number of the first and second internal conductors 105 and 106 can be arranged per unit area. It is thus possible to provide the capacitor 100 having higher capacity than typical capacitors (Al electric field capacitor, a laminated ceramic capacitor, etc.).

### [Method of Forming Capacitor]

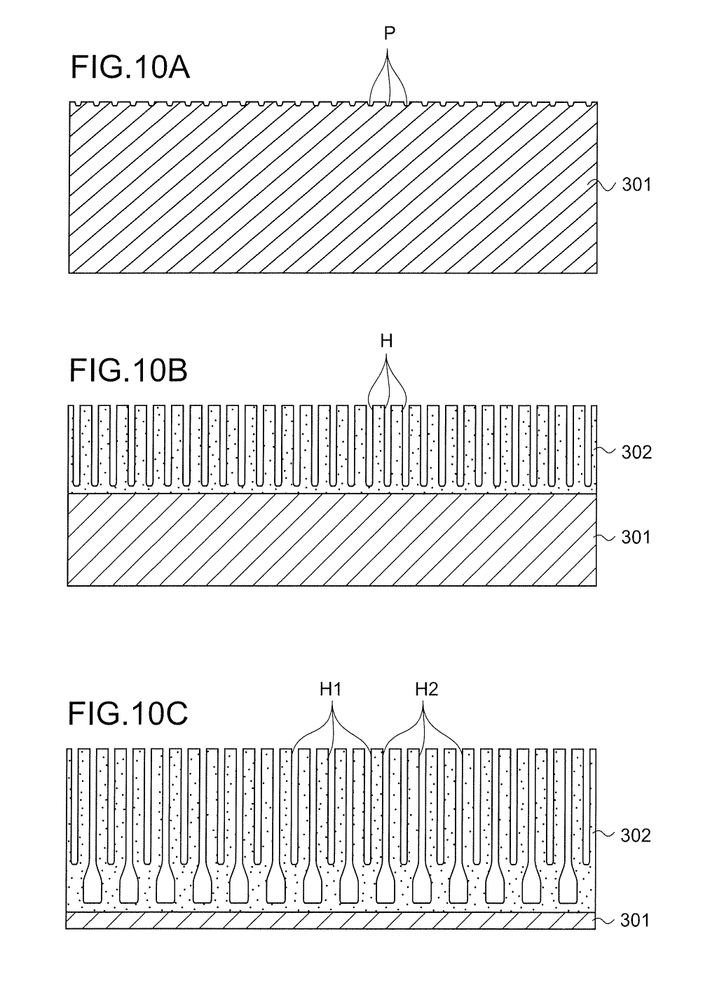

A method of forming the capacitor 100 will be described. FIGS. 10 to 18 are schematic views showing a method of forming the capacitor 100. A plurality of the capacitors 100 can be formed simultaneously by the following method. One of the capacitors 100 will be described below.

FIG. 10A shows a substrate 301 that will be the dielectric layer 101. When the dielectric layer 101 is made of a metal oxide (for example, aluminum oxide), the substrate 301 is made of a metal before oxidation (for example, aluminum). On the surface of the substrate 301, pits P are formed. The pits P have concave structures and are regularly arranged on the surface of the substrate 301. The metal oxide is grown based on the pits P, as described later. The pits P may be formed by any method, e.g., by pressing the substrate 301 with a mold or by etching the surface of the substrate 301, for example.

Next, a voltage is applied using the substrate 301 on which the pits P are formed as an anode in an electrolyte solution. In this way, the metal surface of the substrate 301 is oxidized (anodic oxidized) and a substrate oxide 302 is formed, as shown in FIG. 10B. In this case, by the self-organizing action of the substrate oxide 302, holes H are formed in the substrate oxide 302. The holes H are formed in a direction of oxidation processes, i.e., in a thickness direction of the substrate 301. During the formation, as the pits P are initially formed in the substrate 301, the holes H are formed based on respective pits P in the substrate oxide 302.

After the predetermined time elapses, the voltage applied to the substrate 301 is increased. Pitches between the holes H formed by the self-organizing action are determined depending on the magnitude of the applied voltage. The self-organizing action proceeds so that the pitches of the holes H are enlarged. In this way, some holes H continue to be formed and enlarged, as shown in FIG. 10C. On the other hand, the formation of some holes H stops due to the enlarged pitches of the holes H. Hereinafter, the holes H where the formation stops are referred to as holes H1, and the holes H where the formation continues (the holes are enlarged) are referred to as holes H2.

The conditions of the anodic oxidation can be set arbitrarily. For example, the applied voltage can be set to several V to hundreds V and the processing time can be set to several minutes to several days at a first stage of the anodic oxidation shown in FIG. 10B. The voltage value can be set to several times greater than that in the first stage and the processing time can be set to several minutes to several days at a second stage of the anodic oxidation shown in FIG. 10C. [0047] For example, when the applied voltage at the first stage is set to 40V, the holes H (the holes H1 and H2) each having a hole diameter of 100 nm are formed, and when the applied voltage at the second stage is set to 80V, the holes H2 each has an enlarged hole diameter of 200 nm. By limiting the voltage at the second stage to the above-described range, the numbers of the hole H1 and the hole H2 can be almost the same. By limiting the time for applying the voltage at the second stage within the above-described range, the substrate oxide 302 formed by applying the voltage at the second stage can be thin, while a pitch enlargement of the holes H2 is fully completed. Since the substrate oxide 302 formed by applying the voltage at the second stage is removed at a later step, it is desirable that the substrate oxide 302 is as thin as possible. The solution used for the anodic oxidation can be oxalic acid (0.1 mol/l) controlled at a temperature of 15 to 20° C., for example.

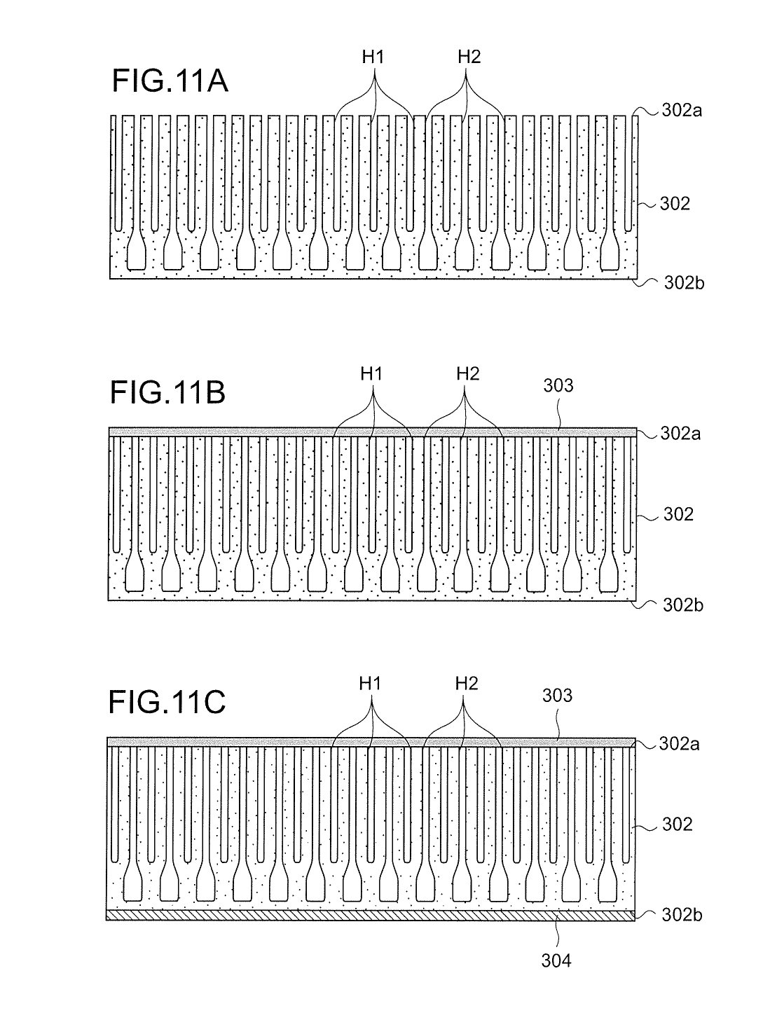

Then, as shown in FIG. 11A, the substrate 301 not oxidized is removed. The removal of the substrate 301 can be done by wet etching, for example. Hereinafter, a surface of the substrate oxide 302 where the holes H1 and H2 are formed is defined as a front surface 302a, and the opposite side thereof is defined as a back surface 302b.

Then, as shown in FIG. 11B, the first conductor layer 303 containing a conductive material is formed on the front surface 302a of the substrate oxide 302. The first conductor layer 303 can be formed by any method including a sputtering method, a vacuum vapor deposition method or the like.

Next, as shown in FIG. 11C, a resist 304 is formed on the back surface 302b of the substrate oxide 302. The resist 304 can be a photoresist, for example.

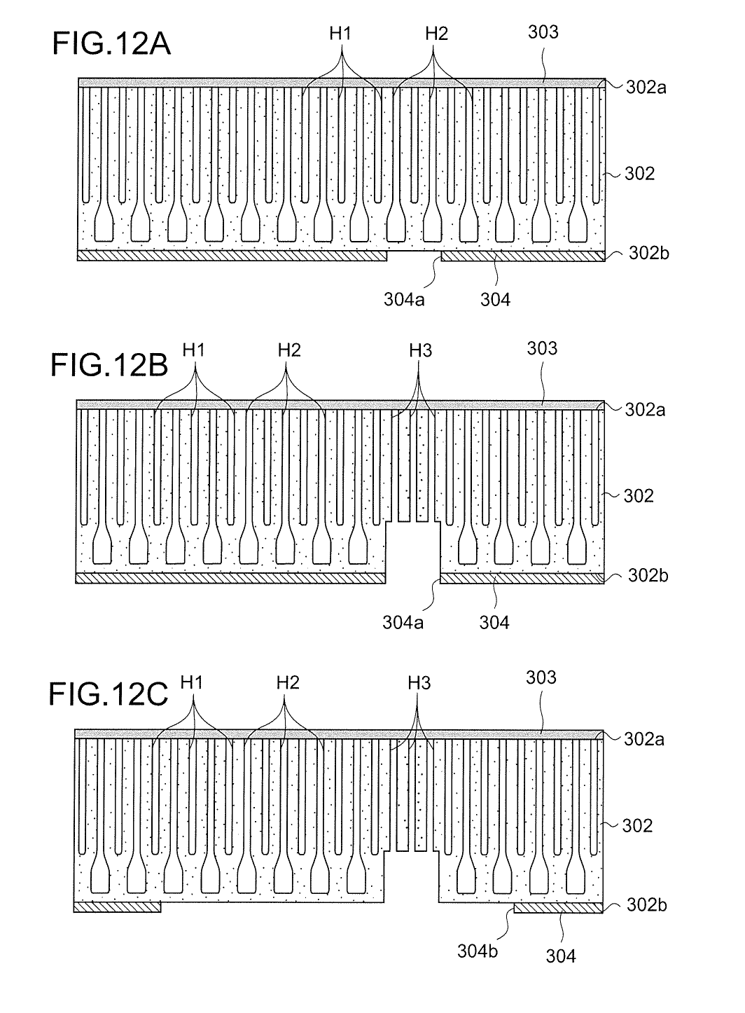

Next, as shown in FIG. 12A, the resist 304 is partly removed to form an opening 304a. The opening 304a can be formed by a photolithography, for example. As an area of the opening 304a defines formation areas of the third internal conductors 107, a size of the opening 304a is determined in view of this.

Next, as shown in FIG. 12B, the substrate oxide 302 is removed from the back surface 302b at a predetermined thickness. The removal can be made by a reactive ion etching (RIE). In this case, the substrate oxide 302 is removed to provide a thickness such that the holes H1 and H2 are communicated with the back surface 302b. Hereinafter, the holes H1 and H2 that are communicated with the back surface 302b by the removal step are referred to as holes H3.

Then, as shown in FIG. 12C, a removal area of the resist 304 is enlarged to form the opening 304b. The opening 304b can be formed by photolithography, for example. As an area of the opening 304b defines formation areas of the first internal conductors 105 and the second internal conductors 106, a size of the opening 304b is determined in view of this.

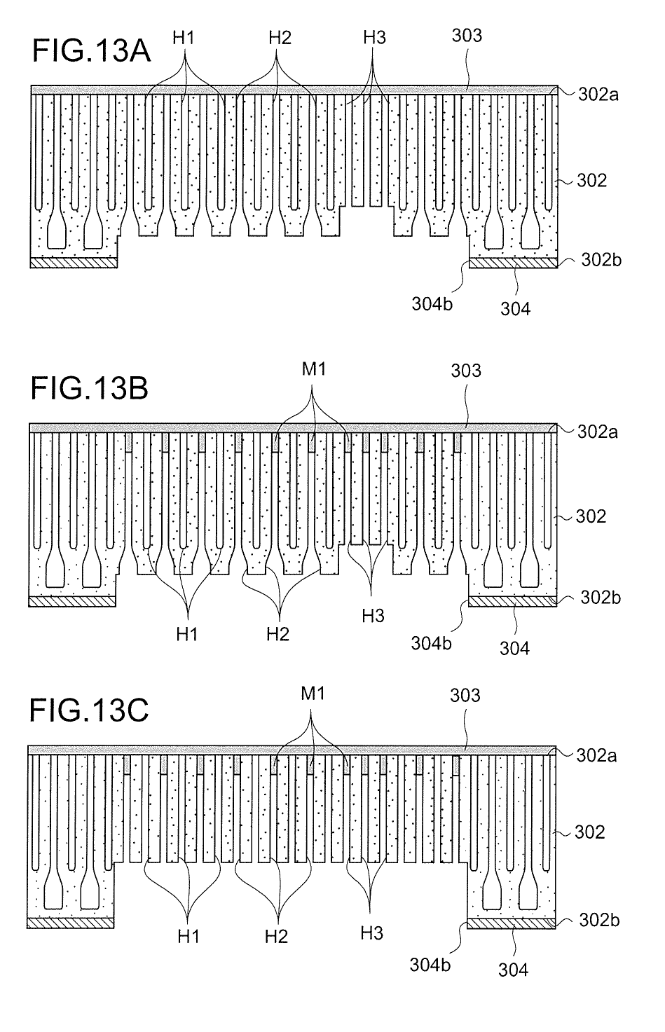

Next, as shown in FIG. 13A, the substrate oxide 302 is again removed from the back surface 302b at a predetermined thickness. The removal can be made by the RIE. In this case, the substrate oxide 302 is removed to provide a thickness such that the holes H2 are communicated with the back surface 302b, but the holes H1 are not communicated with the back surface 302b.

Then, the substrate oxide 302 is electrolytic plated using the first conductor layer 303 as a seed layer. As shown in FIG. 13B, plated conductors M1 are formed in the holes H2 and H3 at a predetermined thickness (length). Since no plating liquid enters into the holes H1, no plated conductors M1 are formed in the holes H1.

Then, as shown in FIG. 13C, the substrate oxide 302 is again removed from the back surface 302b at a predetermined thickness. The removal can be made by the RIE. In this case, the substrate oxide 302 is removed to provide a thickness such that the holes H1 are communicated with the back surface 302b.

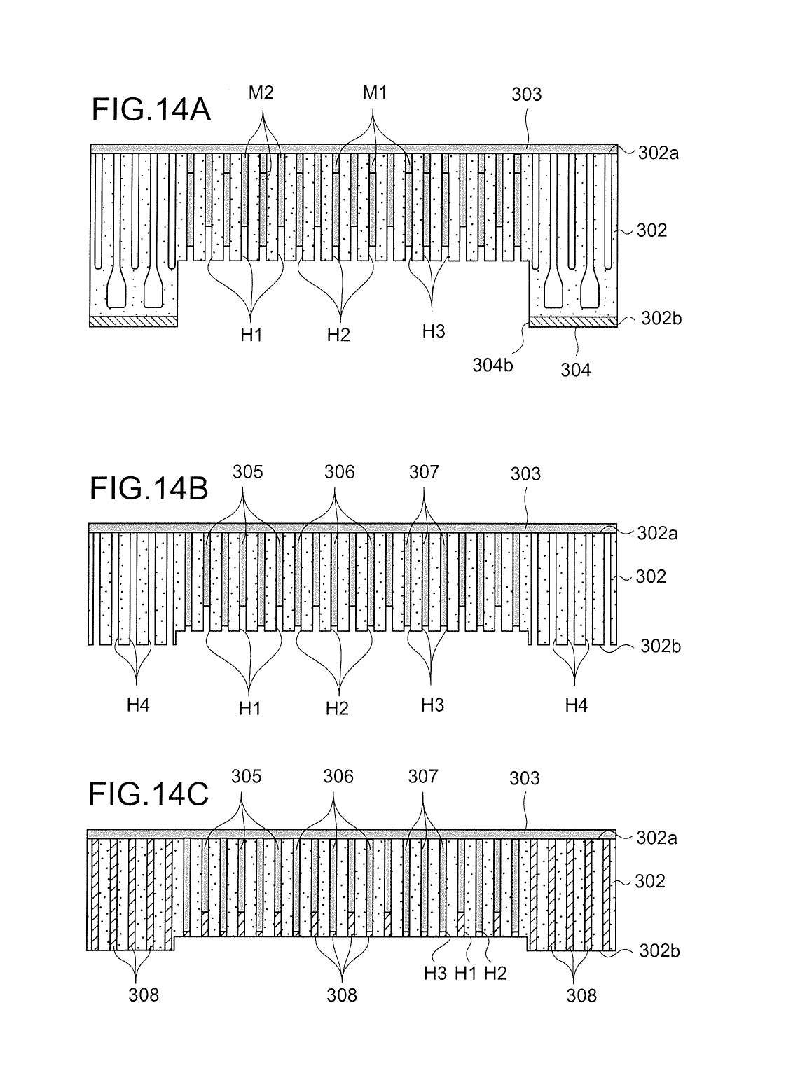

Then, the substrate oxide 302 is again electrolytic plated using the first conductor layer 303 as the seed layer. As shown in FIG. 14A, plated conductors M2 are formed in the holes H1, H2 and H3 at a predetermined thickness (length). The thicknesses of the plated conductors M2 are such that most of the holes H2 and H3 can be filled. Since no plated conductors M1 are formed in the holes H1, the plated conductors M2 filled into the holes H1 have terminal positions different from the plated conductors M2 filled into the holes H2 and H3. The plated conductors M2 may be made of a metal material that is similar or different metal material of the plated conductors M1.

In the following description, the plated conductors M2 filled in the holes H1 are shown as first internal conductors 305, the plated conductors M1 and M2 filled in the holes H2 are shown as second internal conductors 306, and the plated conductors M1 and M2 filled in the holes H3 are shown as third internal conductors 307 (see FIG. 14B).

Then, the resist 304 is removed. As shown in FIG. 14B, the substrate oxide 302 is again removed from the back surface 302b at a predetermined thickness. The removal can be made by the RIE. In this case, the substrate oxide 302 is removed to provide a thickness such that the holes H1 and H2, which are blocked at a position of the resist 304, are communicated with the back surface 302b. Hereinafter, the holes H1 and H2 communicated with the back surface 302b by the removal step are referred to as holes H4.

Then, the insulating material is provided from the back surface 302b to the substrate oxide 302. In this way, as shown in FIG. 14C, voids of the holes H1, H2, H3 and H4 are filled with the insulating material to form internal insulators 308. The insulating material can be the metal oxide similar to that used in the substrate oxide 302, an electrodepositable resin material (for example, polyimide, epoxy, acrylic etc.), SiO or the like. When the holes are filled with the insulating material, it is possible to control pores (micropores) formed in the internal insulators 308 by the filling method. The control of the pores will be described later.

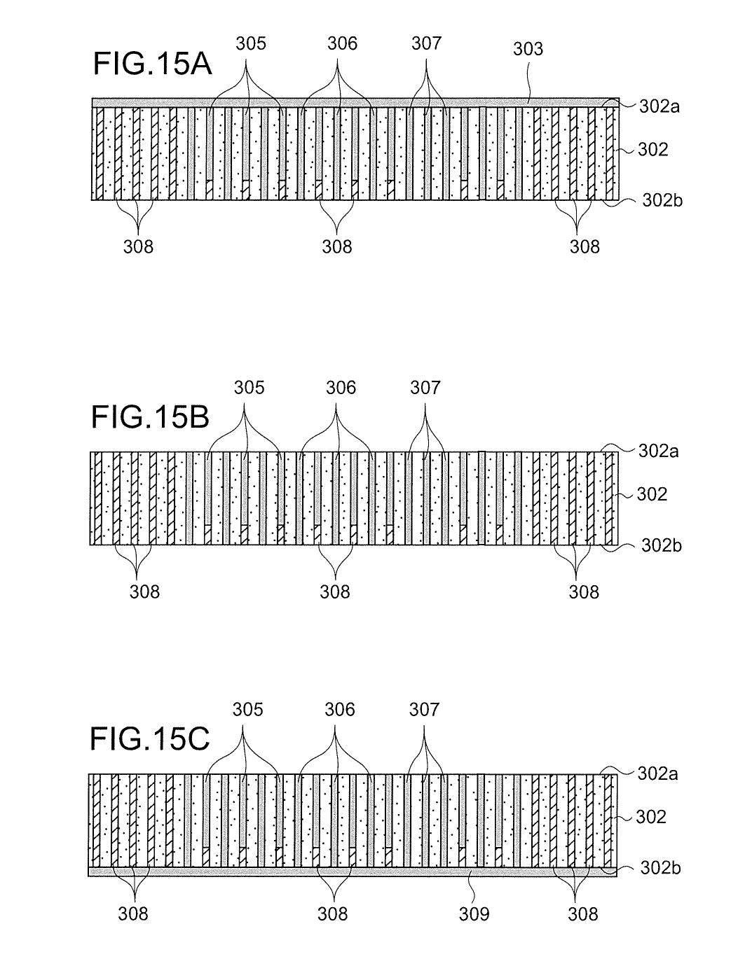

Then, the back surface 302b is mechanically polished. A degree of polishing is such that the second internal conductors 306 and the third internal conductors 307 are exposed at the back surface 302b, and the first internal conductors 305 are not exposed at the back surface 302b, as shown in FIG. 15A. This allows the internal insulators 308 filled in the holes H2 and H3 to be removed.

Then, as shown in FIG. 15B, the first conductor layer 303 is removed. The removal of the first conductor layer 303 can be done by wet etching method, a dry etching method, an ion milling method, a Chemical Mechanical Polishing (CMP) method, or the like.

Then, as shown in FIG. 15C, a second conductor layer 309 including the conductive material is formed on the back surface 302b. The second conductor layer 309 can be formed by any method including a sputtering method, a vacuum vapor deposition method or the like. In this way, the second internal conductors 306 and the third internal conductors 307 are electrically connected to the second conductor layer 309. On the other hand, the first internal conductors 305 are not connected to the second conductor layer 309 by the internal insulators 308.

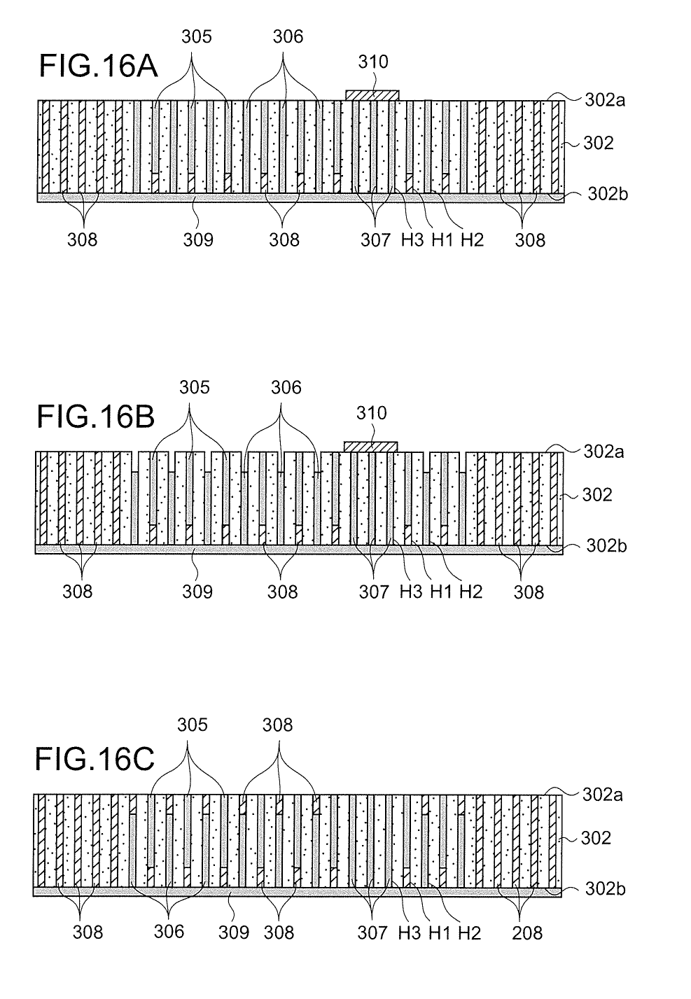

Then, as shown in FIG. 16A, a resist 310 is formed on the front surface 302a. The resist 310 is formed on the front surface 302a where the third internal conductors 307 are formed.

Then, the substrate oxide 302 is electrolytic etched using the second conductor layer 309 as a seed layer. As shown in FIG. 16B, the second internal conductors 306 are conducted to the second conductor layer 309 and are thus etched by electrolytic etching. On the other hand, the first internal conductors 305 are not conducted to the second conductor layer 309 and are not etched by electrolytic etching. The third internal conductors 307 are coated with the resist 310, and are therefore not etched.

Then, the resist 310 is removed, and the insulating material is provided to the substrate oxide 302 from the front surface 302a. In this way, as shown in FIG. 16C, voids of the holes H2 are filled with the insulating material to form internal insulators 308. The insulating material can be the metal oxide similar to that used in the substrate oxide 302, an electrodepositable resin material (for example, polyimide, epoxy, acrylic etc.), SiO or the like.

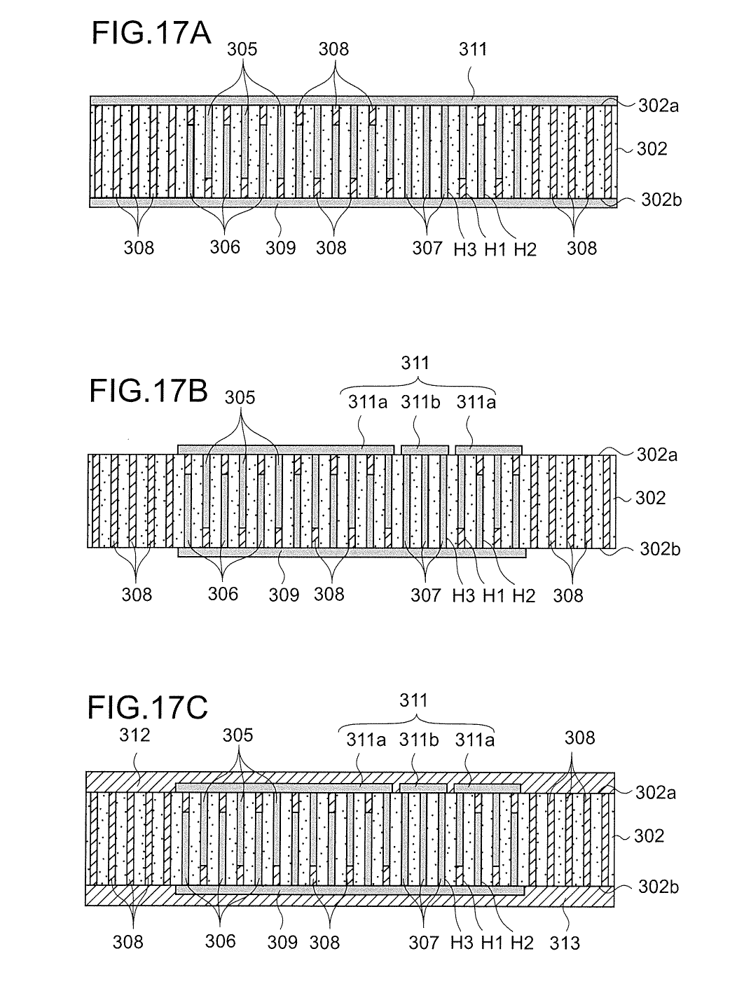

Then, as shown in FIG. 17A, a third conductor layer 311 including the conductive material is formed on the front surface 302a. The third conductor layer 311 can be formed by any method including a sputtering method, a vacuum vapor deposition method or the like. In this way, the first internal conductors 305 and the third internal conductors 307 are electrically connected to the third conductor layer 311. On the other hand, the second internal conductors 306 are not connected to the third conductor layer 311 by the internal insulators 308.

Then, as shown in FIG. 17B, the second conductor layer 309 and the third conductor layer 311 are patterned. The second conductor layer 309 is patterned such that the area where the holes H1, H2 and H3 formed at the back surface 302b are coated (see FIG. 8). The third conductor layer 311 is patterned such that the area where the holes H1, H2 and H3 are formed at the front surface 302a is coated, and the area where the holes H3 are formed is separated from the rest area (see FIG. 7). In this way, the third conductor layer 311 is separated into a first area 311a where the holes H1 and H2 are coated and a second area 311b where the holes H3 are coated. The patterning can be made by any method such as etching.

Then, as shown in FIG. 17C, the front surface 302a and the third conductor layer 311 (the first area 311a and the second area 311b) are coated with the insulating material to form the first protective layer 312. Also, the back surface 302b and the second conductor layer 309 are coated with the insulating material to form the second protective layer 313. The formation of the first protective layer 312 and the second protective layer 313 can be made by any method such as application.

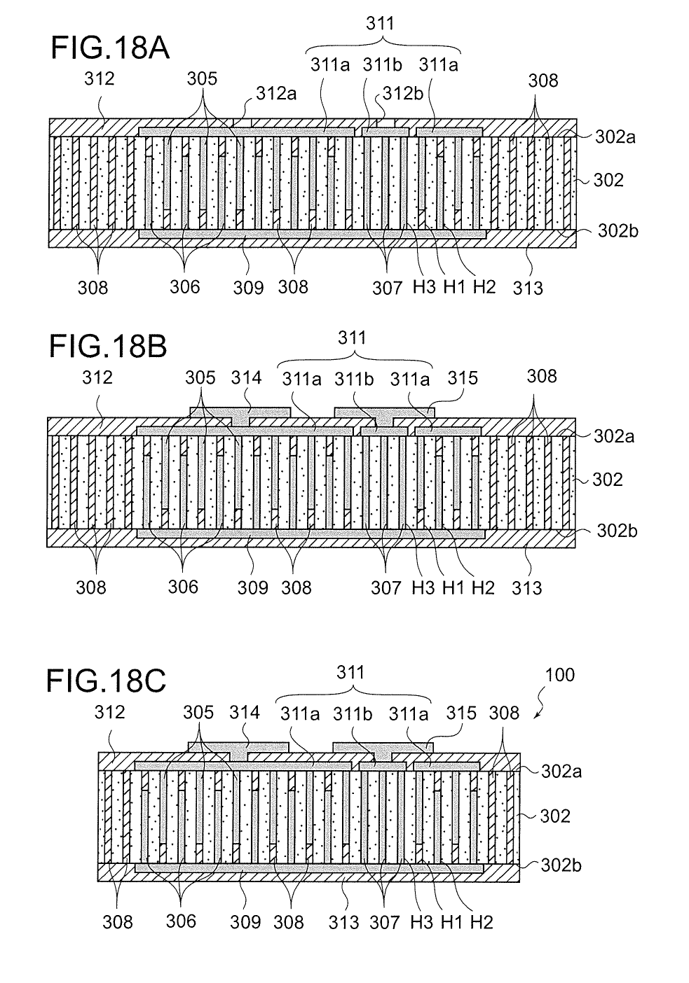

Then, as shown in FIG. 18A, a part of the first protective layer 312 is removed to form a first opening 312a and a second opening 312b. The first opening 312a is formed immediately above the first area 311a of the third conductor layer 311, and the second opening 312b is formed immediately above the third conductor layer 311 and the second area 311b (see FIG. 6). The formation of the first opening 312a and the second opening 312b can be made by any method such as etching.

Then, as shown in FIG. 18B, a first terminal 314 and a second terminal 315 are formed on the first protective layer 312. The first terminal 314 is formed immediately above the first opening 312a so as to be connected to the first area 311a via the first opening 312a. The second terminal 315 is formed immediately above the second opening 312b so as to be connected to the second area 311b via the second opening 312b. The method of forming the first terminal 314 and the second terminal 315 is not especially limited. The preformed first terminal 314 and the second terminal 315 may be inserted and engaged into the first opening 312a and the second opening 312b. Alternatively, the first terminal 314 and the second terminal 315 may be formed on the first protective layer 312 by a film-forming process.

Then, as shown in FIG. 18C, the substrate oxide 302, the first protective layer 312 and the second protective layer 313 are cut such that each includes the area having the first internal conductors 305, the second internal conductors 306 and the third internal conductors 307. In this way, the capacitor 100 is formed, and is separated from adjacent other capacitors 100 (not shown) at the same time.

Here, the substrate oxide 302 corresponds to the dielectric layer 101, the first area 311a of the third conductor layer 311 corresponds to the first external conductor layer 102, the second area 311b of the third conductor layer 311 corresponds to the third external conductor layer 104, and the second conductor layer 309 corresponds to the second external conductor layer 103, respectively. The first internal conductor 305 corresponds to the first internal conductor 105, the second internal conductor 306 corresponds to the second internal conductor 106, and the third internal conductor 307 corresponds to the third internal conductor 107, respectively. The first protective layer 312 corresponds to the first protective layer 108, the second protective layer 313 corresponds to the second protective layer 109, the first terminal 314 corresponds to the first terminal 110, the second terminal 315 corresponds to the second terminal 111, and the internal insulators 308 corresponds to the internal insulators 112, respectively.

As described above, the capacitor 100 can be formed. The method of forming the capacitor 100 is not limited thereto. Other methods of forming the capacitor 100 may be possible.

### [Pores in Internal Insulators]

In the method of forming the capacitor 100 as described above, it is possible to control the pores formed in the internal insulators 308 during the step of filling the holes H with the insulating material (see FIG. 14C and FIG. 16C).

The insulating material can be filled by a series of steps of dropping the insulating material into the substrate oxide 302, applying the insulating material using a spin coater, prebaking, exposing, developing and curing. Among them, in the steps of dropping and curing, it is possible to control the rate of pore formation and the pore size. Specifically, the rate of pore formation depends on a filled amount of the insulating material in the holes H. When the insulating material is filled densely, the pores are almost not formed. When the insulating material is filled sparsely, the rate of pore formation is increased. The filled amount of the insulating material is proportional to a holding time after the insulating material is dropped. In addition, the insulating material having low viscosity is easily filled.

Thus, the rate of pore formation can be controlled by the holding time after the insulating material is dropped and the viscosity of the insulating material. The pore size is controlled by a speed of temperature increase upon curing. Before curing, the insulating material enters into the holes H by its own weight. When the speed of temperature increase is low, small pores are formed because the insulating material is cured slowly and enters into the holes H at the same time. When the speed of the temperature increase is high, large pores are formed because the insulating material is cured rapidly and less enters by its own weight.

As described above, the capacitor 100 includes the internal insulators 112 made of the insulating material, the dielectric layer 101 made of aluminum oxide, the first external conductor layer 102 made of a metal, the second internal conductors 106, and the third internal conductors 107 and the like. As the insulating material has a coefficient of thermal expansion several times larger than other materials, a thermal deformation caused by the internal insulators 112 is generated, once the capacitor 100 is heated.

At this time, the pores formed within the internal insulators 112 can buffer a stress generated when a volume is increased by a thermal expansion of the insulating material, and prevent the thermal deformation caused by the internal insulators 112. Therefore, as described above, by controlling the pores as appropriate in the step of filling the holes H with the insulating material, the capacitor 100 can be formed while the thermal deformation is prevented.

### [Effects of Capacitor]

As described above, as the first terminal 110 and the second terminal 111, both of which are connected to the counter electrodes (the first internal conductors 105 and the second internal conductors 106), are disposed on the same face, the capacitor 100 is easily mounted on the substrate.

### Comparative Example

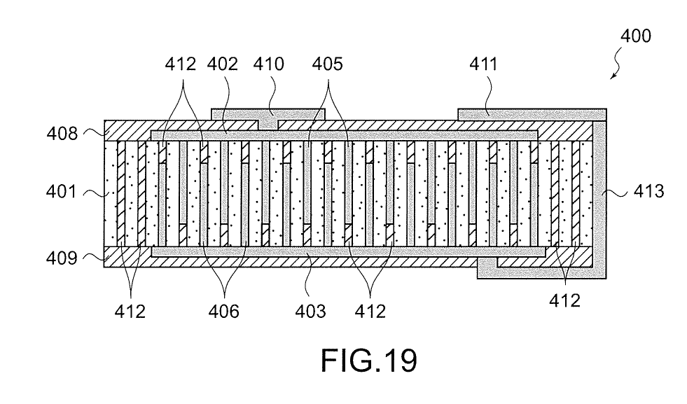

Here, a capacitor having terminals disposed on one face can be also achieved by the following configuration. FIG. 19 is a schematic view showing a configuration of a capacitor 400 according to Comparative Example. The capacitor 400 includes a dielectric layer 401, a first external conductor layer 402, a second external conductor layer 403, first internal conductors 405, second internal conductors 406, a first protective layer 408, a second protective layer 409, a first terminal 410, a second terminal 411, internal insulators 412 and a surface wiring 413.

The first internal conductors 405 that configure one of the counter electrodes of the capacitor 400 are connected to the first terminal 410 via the first external conductor layer 402. The second internal conductors 406 that configure the other of the counter electrodes of the capacitor 400 are connected to the second terminal 411 via the second external conductor layer 403 and the surface wiring 413. The surface wiring 403 is formed from a back surface (at the second protective layer 409) to the front surface (at the first protective layer 408) via a side surface the capacitor 400.

Even by such a configuration, the first terminal 410 and the second terminal 411 may be disposed on the same face of the capacitor 400. However, in the capacitor 400 having the above-described configuration, the surface wiring 413 extending from the back surface to the front surface has a fair length, resulting in an increased ESR (Equivalent Series Resistance) as compared with the capacitor having the second terminal 411 disposed at the back surface.

Also, as the surface wiring 413 is disposed at a side surface of the capacitor 400, the mounting area of the capacitor 400 becomes larger than that of the capacitor having the second terminal 411 disposed at the back surface. In addition, during the formation of the capacitor 400, a step of forming the surface wiring 413 at the side surface of the capacitor 400 is necessary. It is thus impossible to separate respective capacitors 400 in the final step dissimilar to the capacitor 100.

In contrast, in the capacitor 100 according to the embodiment, a distance from the second external conductor layer 103 to the second terminal 111 is shorter than that in the capacitor 400, thereby decreasing the ESR. In addition, the surface wiring formed at the side surface is not necessary in the capacitor 100, thereby minimizing the mounting area.

Furthermore, the second external conductor layer 103 is connected to the second terminal 111 via a plurality of third internal conductors 107 each having a small diameter in the capacitor 100. It is thus possible to ignore a skin effect (an increase of AC resistance) generated when a high-frequency current is applied to the capacitor 100. Also, it is possible to separate the capacitors 100 formed as described above, i.e., formed by the same process, and to form the capacitors 100 per wafer. In other words, the capacitor 100 has a configuration suitable to mass production.

### [Modification]

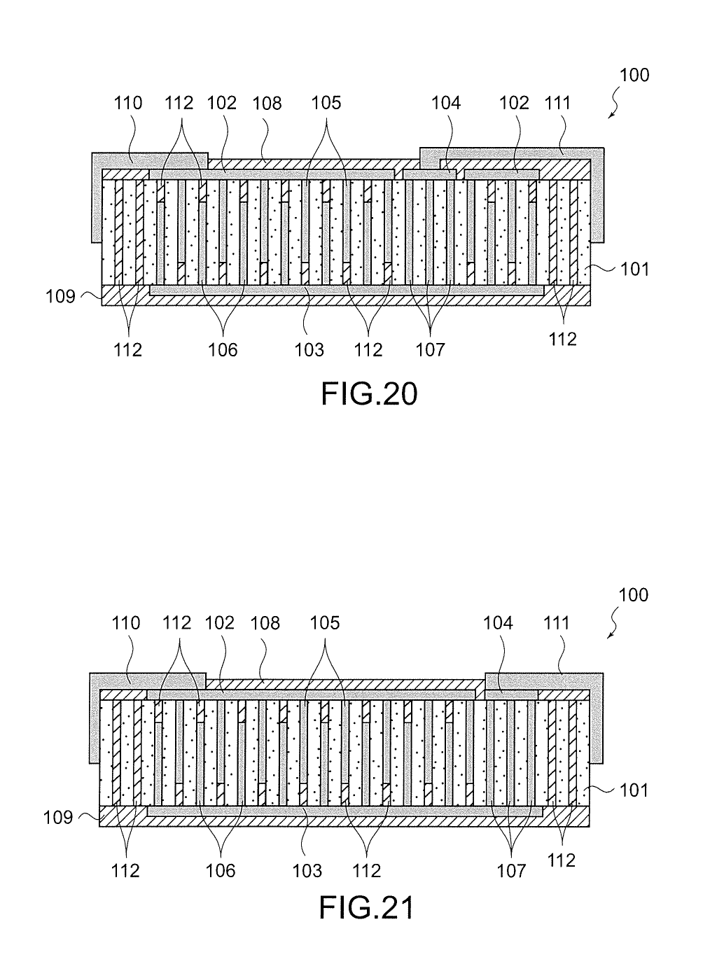

FIGS. 20 and 21 each shows a sectional view of the capacitor 100 according to Modification Example. In the capacitor 100 shown in FIG. 20, the first terminal 110 and the second terminal 111 are extended to a side surface of the capacitor 100. In the capacitor 100 shown in FIG. 21, the third internal conductors 107 and the third external conductor layer 104 are disposed at a peripheral of the capacitor 100, and are connected to the second terminal 111. Each of the capacitors 100 having such configurations can provide the above-mentioned advantages, as the first terminal 110 and the second terminal 111 are disposed at the same face of the capacitor 100.

While the embodiments of the present disclosure are described, it should be appreciated that the invention is not limited to the above-described embodiments, and variations and modifications may be made without departing from the spirit and scope of the present disclosure.

What is claimed is:

1. A capacitor, comprising:
a dielectric layer having a first plane, a second plane opposite to the first plane, and a plurality of through-holes communicated with the first plane and the second plane;
a first external conductor layer disposed on a part of the first plane;
a second external conductor layer disposed on the second plane;
a third external conductor layer disposed on another part of the first plane;
a first internal conductor housed in a part of a plurality of the through-holes and connected to the first external conductor layer;
a second internal conductor housed in another part of a plurality of the through-holes and connected to the second external conductor layer; and
a third internal conductor housed in the other part of a plurality of the through-holes and connected to the second external conductor layer and the third external conductor layer.

2. The capacitor according to claim 1, further comprising:
a first protective layer coating the first external conductor layer and the third external conductor layer;
a second protective layer coating the second external conductor layer;
a first terminal disposed on the first protective layer and connected to the first external conductor layer; and
a second terminal disposed on the first protective layer and connected to the second external conductor layer.

3. The capacitor according to claim 2, wherein
a first opening communicating with the first external conductor layer and a second opening communicating with the third external conductor layer are formed on the first protective layer;
the first terminal is connected to the first external conductor layer via the first opening; and
the second terminal is connected to the third external conductor layer via the second opening.

4. The capacitor according to claim 3, wherein
the dielectric layer is made of aluminum oxide.
